(19) United States
(12) Patent Application Publication
(10) Pub. No.: US 2007/0067303 A1
(43) Pub. Date: Mar. 22, 2007

(54) System and method for user interaction

(76) Inventors: Jukka Linjama, Espoo (FI); Timo J. Erola, Piispanristi (FI); Jakke Makela, Turku (FI); Heikki Huomo, Oulu (FI)

Correspondence Address: MORGAN & FINNEGAN, L.L.P., 3 World Financial Center, New York, NY, 10281-2101, US

(21) Appl. No.: 11/232,692

(22) Filed: Sep. 21, 2005

(51) Int. Cl. G06F 17/30

(52) U.S. Cl. 707/10

(57) ABSTRACT

Systems and methods applicable, for instance, in user interaction. A node and/or other computer might, for instance, come to be juxtaposed with an item, and/or might provide an interface to a user. The interface might, for example, allow the user to navigate among various offerings by moving the node and/or other computer in space. As another example, the interface might operate in a time-based manner. The node and/or other computer might, for instance, perform one or more operations in compliance with selection of one or more offerings by the user.

### FIELD OF INVENTION

This invention relates to systems and methods for user interaction.

### BACKGROUND INFORMATION

In recent times, there has been an increase in the use of nodes and/or other computers. For example, many users have come to prefer using nodes and/or other computers (e.g., wireless nodes) for activities such as, for instance, work-related activities, household-related activities, and/or communications-related activities over other ways of performing such activities.

Accordingly, there may be interest in technologies applicable, for instance, in node operation.

### SUMMARY OF THE INVENTION

According to embodiments of the present invention there are provided systems and methods applicable, for instance, in user interaction.

For example, in various embodiments a node and/or other computer might come to be juxtaposed with an item, and/or might provide an interface to a user. The interface, in various embodiments, might be one allowing the user to navigate among various offerings by moving the node and/or other computer in space, and/or might operate in a time-based manner.

The node and/or other computer might, in various embodiments, perform one or more operations in compliance with selection of one or more offerings by the user.

### BRIEF DESCRIPTION OF THE DRAWINGS

FIG. 1 shows exemplary steps involved in juxtaposition operations according to various embodiments of the present invention.

FIG. 2. shows exemplary steps involved in interface operations according to various embodiments of the present invention.

FIG. 3 shows exemplary steps involved in use operations according to various embodiments of the present invention.

FIG. 4 shows an exemplary computer.

FIG. 5 shows a further exemplary computer.

### DETAILED DESCRIPTION OF THE INVENTION

General Operation

According to embodiments of the present invention there are provided systems and methods applicable, for instance, in user interaction.

For example, in various embodiments a node and/or other computer might, by action of its user, come to be juxtaposed with an item. Moreover, the user's node and/or other computer might, in various embodiments, provide an interface to the user. Such provision might, for instance, be responsive to the juxtaposition.

The interface might, in various embodiments, be one presenting various offerings to its user. Moreover, the interface might, in various embodiments, be one allowing the user to navigate among various offerings by moving the node and/or other computer in space. In various embodiments, the interface might operate in a time-based manner in allowing its user to navigate among various offerings.

The user might, in various embodiments, be able to perform one or more actions (e.g., moving the node and/or other computer in space, juxtaposing the node and/or other computer with an item, and/or employing the node and/or other computer in reading a memory element) to indicate selection of one or more offerings. The node and/or other computer might, in various embodiments, perform one or more operations in compliance with such selection by the user.

Various aspects of the present invention will now be discussed in greater detail.

Juxtaposition Operations

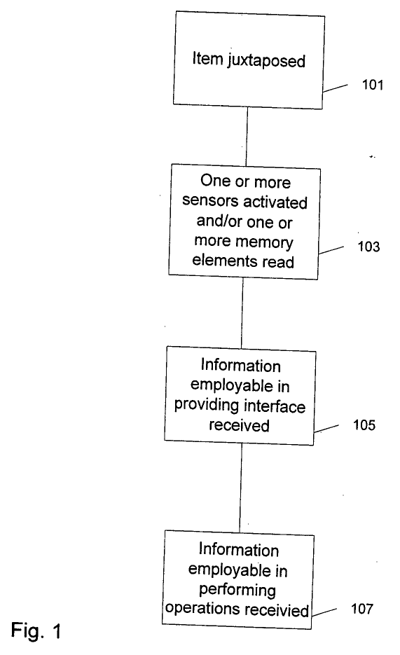

With respect to FIG. 1 it is noted that, according to various embodiments of the present invention, a user may act to juxtapose her node and/or other computer (e.g., a wireless node) with an item (step 101). Such an item might, for example, be another node and/or other computer, an appliance (e.g., a microwave, dishwasher, washing machine, dryer, and/or stove), a consumer electronics device (e.g., a piece of audio equipment, video equipment, recording equipment, and/or communications equipment), a medical device (e.g., a patient support device and/or a diagnostic device), a node and/or other computer peripheral (e.g., a printer, a camera, and/or a scanner), a memory element (e.g., a radio frequency identification (RFID) tag, an iButton, a barcode, and/or an e-code), a network access point (e.g., a wired or wireless network access point), a vehicle, a piece of industrial equipment (e.g., a piece of manufacturing and/or diagnostic equipment), a storage unit (e.g., a storage tank, a storage crate, and/or a storage area), a vending device, a fee collection device (e.g., a toll collection device and/or a parking lot fee collection device), an automatic teller device, an elevator, a climate control device, a piece of office equipment, a swimming pool, a hot tub, lighting, a security system, a poster, a display (e.g., a promotional display), and/or a kiosk. It is noted that, in various embodiments, an item might include an integrated memory element. To illustrate by way of example, a memory element might be integrated into a poster.

It is noted that juxtaposition might, in various embodiments, involve the user touching her node and/or other computer to an item. It is further noted that, in various embodiments, juxtaposition might involve the user moving her node and/or other computer into close proximity with an item (e.g., within two inches of the item) such that the node and/or other computer does not touch the item.

Juxtaposing of the user's node and/or other computer with the item might, for instance, involve activation of one or more sensors and/or reading of one or more memory elements (step 103). Such memory elements might, for example, be of the sort discussed above. Such sensors might, for example, exist in the item and/or in the user's node and/or other computer, and/or might act to indicate to the item and/or to the node and/or other computer that the item and the node and/or other computer are juxtaposed.

Such sensors might be implemented in a number of ways. For example sensors for inductive sensing, capacitive sensing, conductive sensing, pressure sensing, temperature sensing, texture sensing, ultrasonic sensing, near field communication (NFC) sensing, and/or image sensing might be employed. It is noted that, in various embodiments, such juxtaposition might or might not involve the user lining up one or more areas of her node and/or computer with one or more areas of the item.

According to various embodiments, data may, for example, be received from the item by the user's node and/or other computer. Such receipt might, for instance, occur with and/or subsequent to the juxtaposition. As another example, the user's node and/or other computer might, alternately or additionally, retrieve data from an accessible store with and/or subsequent to the juxtaposition. Such an accessible store might, for instance, be a cache of the node and/or other computer, and/or a server accessible by the node and/or other computer. It is noted that, in various embodiments, the node and/or other computer might receive from the item data employable in determining data to be retrieved from such an accessible store.

Receipt of data by the node and/or other computer from the item might occur in a number of ways. For example, in the case where juxtaposition involved reading of one or more memory elements, the data might be received through the reading. As another example, the item that had been juxtaposed might communicate the data to the user's node and/or other computer responsive to the juxtaposition.

Such communication might be implemented in a number of ways. For example, Bluetooth, Wireless Fidelity (WiFi), Infrared Data Association (IrDA), General Packet Radio Service (GPRS), Universal Mobile Telecommunications Service (UMTS), Ultra Wide Band (UWB), wired network (e.g., Ethernet), Remote Method Invocation (RMI), Java Messaging Service (JMS), Simple Object Access Protocol (SOAP), sockets, pipes, Object Exchange (OBEX) Object Push Profile (OPP), email, Multimedia Messaging Service (MMS), and/or Short Message Service (SMS) might be employed.

Such WiFi might, for instance, be IEEE 802.11b and/or IEEE 802.11g. It is noted that, in various embodiments, a juxtaposable item may act to emulate a memory element. To illustrate by way of example, a juxtaposable item that neither included a memory element (e.g., an RFID tag) nor was a memory element (e.g., an RFID tag) might act to emulate a memory element (e.g., an RFID tag). Accordingly, for instance, the item might be able to communicate in accordance with established protocols for the sort of memory element being emulated (e.g., an RFID tag).

The data received by the user's node and/or other computer might, for example, include information employable by the node and/or other computer in providing an interface to its user (e.g., an interface navigable by the user by moving the node and/or other computer in space) (step 105). The information employable by the node and/or other computer in providing an interface to its user might, in various embodiments, include, for instance, Hypertext Markup Language (HTML) data, Extensible Markup Language (XML) data, and/or User Interface Markup Language (UIML) data, and/or specification of and/or description of one or more offerings. Such description might, for example, include one or more teasers and/or advertisements.

As another example, the data received by the user's node and/or other computer might include information employable by the node and/or other computer in performing one or more operations (e.g., operations responsive to offering selection by the user) (step 107). Such operations might, for instance, be ones corresponding to offerings, and/or might include operations controlling the item and/or interacting with the item, and/or access operations. Such access operations might, for example, include operations to access services and/or to receive various data (e.g., via the item).

Interface Operations

The user's node and/or other computer may, according to various embodiments, perform one or more operations to provide an interface to the user. Such an interface might, for instance, make use of data of the sort discussed above and/or be provided to the user in response to juxtaposition of the sort discussed above.

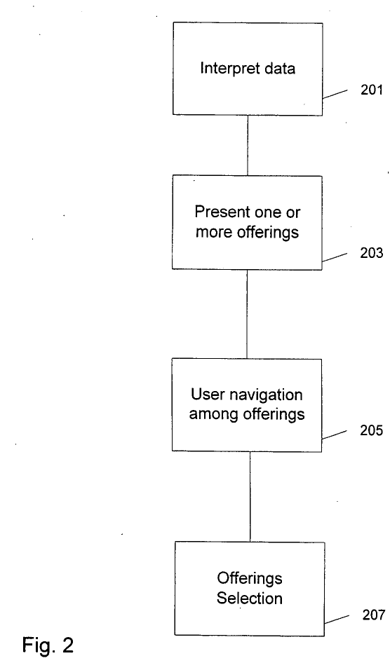

With respect to FIG. 2 it is noted that such an interface might be implemented in a number of ways. For instance, one or more offerings might be presented to the user on a display of the node and/or other computer (step 203). The user might, in various embodiments, be able to navigate among the offerings (step 205) and/or be able to select offerings (step 207). In various embodiments, interface might be provided via interpretation of, for instance, HTML, XML, and/or UIML data (step 201).

Offerings might, for example, be presented to the user in a manner indicating to the user that she may navigate among the offerings and/or select offerings. Accordingly, for instance, Graphical User Interface (GUI) widgets such as buttons might be presented for the offerings. The user might, in various embodiments, be able to navigate among offerings by moving the node and/or other computer in space. Such movement might, for instance, include shaking, tilting, and/or tapping the node and/or other computer.

Such navigation via moving the node and/or other computer might, in various embodiments, be direction-dependent. For example, the user might be able to move (e.g., shake, tilt, and/or tap) the node and/or other computer in the direction she wished to navigate among the offerings. To illustrate by way of example, the node and/or other computer might present an indicator (e.g., a highlight and/or pointer) on the display, and moving the node and/or other computer in a particular direction could cause the indicator to move in that direction. Via such operation the use could, for instance, move the indicator among displayed offerings (e.g., among corresponding widgets). It is noted that, in various embodiments, directional movement of the node and/or other computer could, as an alternative to or in addition to moving an indicator, cause display of additional offerings. For instance, directional movement of the node and/or other computer could cause display of offerings that the node and/or other computer considered to be located off-display within the direction in which the user moved the node and/or other computer.

It is noted that, in various embodiments, the node and/or other computer might perform one or more vibrations. For example, the node and/or other computer might vibrate upon navigation to an offering. Such vibration might, in various embodiments, be of a limited duration (e.g., vibration might occur for a particular number of seconds after navigation to an offering). To illustrate by way of example, the node and/or other computer might vibrate upon the indicator being moved to a displayed offering. As another example, the node and/or other computer might vibrate during periods of times of offering change. To illustrate by way of example, the node and/or other computer might vibrate while the indicator was being moved from one offering to another, and stop upon arrival at an offering.

It is further noted that, in various embodiments, such navigation via moving the node and/or other computer might be direction-independent. Such functionality might be implemented in a number of ways. For example, such functionality might be implemented in a manner similar to that discussed above with respect to direction-dependent operation, but such that rather than movement of the node and/or other computer in a particular direction causing navigation in that direction (e.g., movement of an indicator in that direction), movement of the node and/or other computer would result in navigation to a next waypoint (e.g., movement of an indicator to a next offering) regardless of the direction in which the node and/or other computer was moved.

Accordingly, for instance, the node and/or other computer might consider available offerings to exist in a particular order, and movement of the node and/or other computer could cause navigation to the next offering in the order, without regard to the particular direction in which movement of the node and/or other computer occurred. In various embodiments, the node and/or other computer might consider such order to loop such that, for instance, navigation past the last offering would result in navigation to the first offering. Vibration functionality might, in various embodiments, be implemented for direction-independent operation. Such functionality might, for example, be implemented in a manner analogous to that discussed above.

It is additionally noted that, in various embodiments, navigation among offerings might be time-based. For example, each available offering might be displayed to the user for a particular period of time, and upon the expiration of that period of time a next offering might be displayed. The node and/or other computer might, for instance, perhaps in a manner analogous to that discussed above, consider available offerings to exist in a particular order, and expiration of the period of time could cause navigation to the next offering in the order. In the case where the last offering was being displayed expiration of the period of time might, for instance, perhaps in a manner analogous to that discussed above, result in navigation to the first offering.

The node and/or other computer might, in various embodiments, indicate to the user the amount of time until display of a next offering and/or time remaining for display of current offering. Such functionality might be implemented in a number of ways. For example, the node and/or other computer might display (e.g., via running timer display) elapse time to display of next offering and/or elapse time remaining for display of a currently-displayed offering. As another example, vibration of the node and/or other computer might be employed to convey to the user amount of time until display of a next offering and/or time remaining for display of current offering. Such functionality might be implemented in a number of ways. For example, the node and/or other computer might vibrate for a certain amount of time before end of display of a currently-displayed offering (e.g., 10 seconds before end of display). As another example, the node and/or other computer might employ vibration of rising and falling intensity. For example, vibration might rise in intensity starting with initial display of an offering, peak in intensity half way through display time of that offering, and fall in intensity for the rest of the display period. As another example, a vibration intensity pattern might be employed that rose starting a period of time before change of displayed offering, peaked at time of change, and fell thereafter.

The node and/or other computer may, for instance, provide functionality whereby by the user can select one or more offerings. Such functionality may be implemented in a number of ways. For example, the user might be able to select a currently-displayed offering (e.g., an offering at which the indicator is located) by moving the node and/or other computer (e.g., shaking, tilting, and/or tapping the node and/or other computer). To illustrate by way of example, the user might shake, tilt, and/or tap the node and/or other computer in the case where the indicator was at a desired offering. It is noted that, in various embodiments, selection might involve multiple movements of the node and/or other computer (e.g., double shaking, double tapping, and/or double tilting, and/or one of shaking, tapping, and tilting followed by a different one of shaking, tapping, and tilting). It is further noted that, in various embodiments, selection via movement of the node and/or other computer might involve the node and/or other computer being spatially moved in accordance with one or more predefined selection gestures. Such gestures might, for instance, be defined by a system administrator, user, and/or network provider.

As another example of offering selection, the user might juxtapose her node and/or other computer with one or more items (e.g., of the sort discussed above) to select a currently-displayed offering (e.g., an offering at which the indicator was located). Such am item might, in various embodiments, be the item that had initially been juxtaposed.

As noted above, in various embodiments juxtaposition with an item may involve reading of one or more memory elements. As yet another example of offering selection, the user might employ her node and/or other computer in reading one or more memory elements (e.g., of the sort discussed above) to select a currently-displayed offering (e.g., an offering at which the indicator was located). Such reading of a memory element might, in various embodiments, be with juxtaposition with an item as discussed above, or be separate from such action. It is further noted that such a memory element might be integrated into a juxtaposable item, and/or be separate therefrom.

It is noted that, in various embodiments, the node and/or other computer might act to confirm that the user was holding the node and/or other computer at time of selection. Such functionality might, for example, be implemented to prevent unintentional selection (e.g., the user selecting an offering by mistake) and/or undesired selection (e.g., selection being done not by the user, but by a malicious third party). Such confirmation functionality might be implemented in a number of ways. For example, one or more capacitive sensors, conductivity sensors, temperature sensors, pressure sensors, and/or biometric sensors (e.g., fingerprint sensors) might be employed. It is further noted that, in various embodiments, the node and/or other computer might vibrate in response to offering selection and/or to confirm offering selection.

As discussed above, in various embodiments functionality involving movement of the node and/or other computer may be implemented. Implementation of such functionality might, for example, involve the use of one or more sensors such as accelerometers and/or tilt sensors.

The node and/or other computer may, according to various embodiments of the present invention, be able to make a wide variety of offerings available to its user. The particular offerings made available at a given time might, for instance, correspond to an item with which the user juxtaposed her node and/or other computer.

For example, in the case where the item that had been juxtaposed was another node and/or other computer, an appliance, a consumer electronics device, a medical device, a piece of industrial equipment, a piece of office equipment, a swimming pool, a hot tub, lighting, a climate control device, a security system, a node and/or other computer peripheral, a memory element, a network access point, a storage unit, a vending device, a fee collection device, an automatic teller device, a poster, a display, and/or a kiosk, offerings made available subsequent to juxtaposition with the item might, for instance, include offerings of access (e.g., via the item), control (e.g., of the item), and/or interaction (e.g., with the item). Such access might, for example, include services access and/or network access. Such interaction might, for example, include data transfer, interface, and/or data connection.

Such data transfer might, for instance, include receipt of offered media and/or information. Such a poster, a display, and/or a kiosk might, for instance, be one promoting entertainment, a product, and/or a service. Such data connection might, for instance, allow for gaming (e.g., multiplayer gaming) and/or productivity data connection.

It is noted that, according to various embodiments of the present invention, interface provision may be such that the user can interact with her node and/or other computer without needing to employ and/or unlock the keyboard or keypad of her node and/or other computer. Moreover, in various embodiments one-handed operation may be possible.

Accordingly, in various embodiments the user might, for example, be able to employ her node and/or other computer in conjunction with various sorts of items (e.g., items of the sorts discussed above such as, for instance, network access points) without needing to unlock the keyboard and/or keypad of her node and/or other computer or employ more than one hand, be able to employ her node and/or other computer in conjunction with various sorts of items (e.g., items of the sorts discussed above such as, for instance, industrial equipment) without needing to remove gloves or other articles of clothing or safety apparatus, and/or be able to employ her node and/or other computer in conjunction with various sorts of items even in the case where she has one or more physical and/or mental disabilities, and/or is unable to read.

It is noted that, in various embodiments, some or all of keypad and/or keyboard functionality of the user's node and/or other computer might be replaced by functionality of the sort discussed above wherein the keyboard and/or keypad is not used. Such might, in various embodiments, allow for keyboard, keypad, and/or touch screen elimination, and/or might be considered to provide advantages including, for instance, decreasing input device dirt-related problems and/or touch screen problems (e.g., sensitivity problems and/or stylus necessity). Functionality might, for example, be implemented wherein an on-screen keyboard and/or keypad is presented, and navigation among and/or selection of displayed keys and/or buttons is implemented in a manner analogous to one or more of the ways discussed above.

It is further noted that, in various embodiments, in addition to or as an alternative to such on-screen keyboard and/or keypad functionality, each key of a physical keyboard and/or keypad of the user's node and/or other computer might be able to be individually lit and/or highlighted, and functionality analogous to that discussed above could be implemented wherein the user could navigate among the keys (e.g., in one or more ways discussed above) such that the light and/or highlight moved among the keys, and/or could select a lit and/or highlighted key in a manner analogous to that discussed above. Such lighting and/or highlighting might, for instance, be via conventional and/or organic light emitting diodes (LEDs).

It is noted that although various functionality has been discussed herein as being presented on a display of the user's node and/or other computer, other alternatives may be implemented. For example, in various embodiments, functionality analogous to that discussed above may be implemented such that display of the sort discussed above is alternately or additionally presented on a display of an item that had been juxtaposed. Accordingly, for instance, action of the sort discussed above (e.g., movement of the user's node and/or other computer, and/or juxtaposition) might result in navigation among and/or selection of offerings presented on a display of an item that had been juxtaposed.

It is additionally noted that, in various embodiments, voice synthesis by the user's node and/or other computer might be employed in a manner analogous to that discussed above with respect to vibration in addition to or in place of such above-described vibration functionality. Alternately or additionally, in various embodiments voice synthesis might be employed to provide functionality analogous to that discussed above with respect to visual display. Accordingly, for instance, voice synthesis might be employed to describe available offerings, to indicate navigation among offerings, and/or to confirm offering selection. It is noted that, in various embodiments, such voice synthesis functionality might be employed in lieu of and/or in addition to display functionality of the sort discussed above.

Use Operations

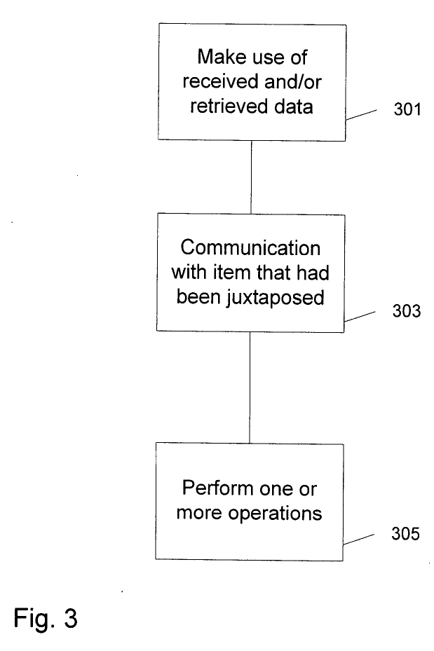

With respect to FIG. 3 it is noted that, according to various embodiments of the present invention, one or more operations may be performed by the node and/or other computer (e.g., in accordance with selection of one or more offerings by the user) (step 305). Such performance might, for example, make use of data received and/or retrieved by the node and/or other computer (e.g., data of the sort discussed above received from the item that had been juxtaposed) (step 301). As another example, such performance may involve communication between the user's node and/or other computer and the item that had been juxtaposed (step 303). Such communication might be performed in a number of ways. For example, such communication might be performed in a manner analogous to that discussed above (e.g., Bluetooth might be employed).

A variety of operations may, in various embodiments, be performed by the user's node and/or other computer (e.g., in accordance with selection of one or more offerings by the user). For example, the node and/or other computer might act to retrieve offered media and/or information, and/or to access one or more offered services. In performing such operations the node and/or other computer might, for example, employ received and/or retrieved data including, for instance, one or more locations from which the offered media and/or information could be received (e.g., one or more Uniform Resource Locator (URLs), network addresses, telephone numbers, and/or identifiers might be employed), one or more credentials to be provided in order to receive the offered media and/or information, and/or information employable in communicating with the item that had been juxtaposed (e.g., one or more Uniform Resource Locator (URLs), network addresses, telephone numbers, and/or identifiers). It is further noted that, in performing such operations, the node and/or other computer might communicate, perhaps in a manner analogous to that discussed above, with the item that had been juxtaposed and/or with one or more locations from which the offered media and and/or information may be received.

As another example, the user's node and/or other computer might act to control the item that had been juxtaposed in accordance with the user's selection. For instance, the user's node and/or other computer might act to act to have the item perform one or more particular operations corresponding to the user's selection. To illustrate by way of example, in the case where the item was a climate control system, the node and/or other computer might act to have the item lower room temperature in the case where the user selected a “lower room temperature” offering. To further illustrate by way of example, in the case where the item was an intravenous delivery machine medical device, the node and/or other computer might act to have the item dispense a particular amount of medication per time unit in the case where the user selected a corresponding offering.

In performing such operations the user's node and/or other computer might, for example, employ received and/or retrieved data including, for instance, one or more commands and/or command formats for the item that had been juxtaposed, one or more credentials to be provided in order to control the item, and/or information employable in communicating with the item (e.g., of the sort discussed above). It is further noted that, in performing such operations, the node and/or other computer might, perhaps in a manner analogous to that discussed above, communicate with the item that had been juxtaposed.

As yet another example, the user's node and/or other computer might act to interface with the item that had been juxtaposed, perform data transfer with the item, and/or receive network access via the item. In performing such operations the user's node and/or other computer might, for example, employ received and/or retrieved data including, for instance, one or more protocols for such interface, data transfer, and/or network access, one or more credentials to be provided in order to perform such data transfer, perform such interface, and/or receive such network access, and/or information employable in communicating with the item that had been juxtaposed (e.g., of the sort discussed above). It is further noted that, in performing such operations, the node and/or other computer might, perhaps in a manner analogous to that discussed above, communicate with the item that had been juxtaposed.

As an additional example, the user's node and/or other computer might present to its user an offering of receiving particular HTML data such that one or more corresponding bookmarks are received by the node and/or other computer, and/or such that browser software at the node and/or other computer is launched and directed to one or more particular websites. The user's node and/or other computer could then act in accordance with the user's offerings selection. As a further example, the user's node and/or other computer might present to the user offerings of receiving particular information via a number of formats. To illustrate by way of example, the user might be offered receiving particular information via HTML, text, and/or Portable Document Format (PDF). The user's node and/or other computer could then, for instance, act in accordance with the user's offerings selection.

Security and Power Saving Operations

Various security and/or power saving functionality may, according to various embodiments of the present invention, be implemented. For example, a power savings mode might be implemented wherein hardware other than memory element reading hardware (e.g., RFID tag reading hardware) and/or juxtaposition sensor hardware is inactive. Other hardware of the node and/or other computer, might for instance, be activated as necessary. For example, other hardware might be activated after the user has, for instance as discussed above, juxtaposed the node and/or other computer with an item, and/or performed memory element reading employing her node.

As another example, in various embodiments hardware of the user's node and/or other computer other than wireless hardware (e.g., Bluetooth and/or WiFi hardware) might be inactive, and other hardware of the node and/or other computer might become active in response to receipt of a wakeup message dispatched by a juxtaposable item. Such functionality might, for instance, be implemented such that juxtaposable items would periodically send wakeup messages to nodes and/or other computers. Such wakeup message functionality might be implemented in a number of ways. For example, email, MMS, SMS, and/or OBEX OPP might be employed. In various embodiments, the user's node and/or other computer might return to a state of other than wireless hardware being inactive in the case where its user did not perform any operations involving the item (e.g., juxtaposing the node and/or other computer with the item) for a period of time after receipt of the wakeup message.

It is further noted that, in various embodiments, the item might enter an inactive state in the case where it was not juxtaposed with the user's node and/or other computer within a certain period of time after dispatch of the message. It is additionally noted that, in various embodiments, the user's node and/or other computer might not accept the message, but instead inform the user (e.g., via a GUI and/or other interface) that a message has been received. In the case where the user wanted to receive the message itself the user could, for example, juxtapose her node and/or other computer with the item.

It is noted that, in various embodiments, various of the power saving operations discussed as being performed by the user's node and/or other computer might alternately or additionally be performed by the item, or vice versa. Accordingly, for instance, the user's node and/or other computer might alternately or additionally dispatch a wakeup message to the item, and item might become active in response to receipt of that message, the item having previously been in a state wherein hardware other than Bluetooth and/or WiFi hardware was inactive. It is additionally noted that, in various embodiments, an item and/or the user's node and/or other computer might be in an inactive state prior to dispatching a wakeup message, might enter an active or partially active state (e.g., a partially active state where hardware other than Bluetooth and/or WiFi hardware was inactive) with dispatch of the wakeup message, and might return to the inactive state in the case where juxtaposition did not occur within a period of time.

As yet another example, in various embodiments various hardware of the node and/or other computer other than hardware necessary to sense a button and/or key press, and/or hardware necessary to sense movement of the node and/or other computer, might be inactive, and the user could bring her node and/or other computer to an active state by pressing one or more buttons and/or keys (e.g., one or more particular buttons and/or keys ), and/or by moving the node and/or other computer (e.g., performing a particular shaking, tilting, and/or tapping). It is noted that, in various embodiments, the one or more buttons and/or keys pressed to bring the node and/or other computer to an active state could correspond to one or more soft keys.

Various security-related functionality may, in various embodiments, be implemented. Such functionality might, for instance, be viewed as providing benefits including preventing unintentional and/or unwanted actions, and/or preventing hostile attacks (e.g., hostile attacks making use of juxtaposable items).

For example, in various embodiments juxtaposition with an item (e.g., juxtaposition involving reading of one or more memory elements) might not automatically lead to any offerings being considered to be selected by the user, and/or might not automatically lead to the node and/or other computer performing operations to accept any offerings. To illustrate by way of example, reading of a memory element might not lead automatically to a service request.

As another example, as discussed above the node and/or other computer might, in various embodiments, act to confirm that the user was holding the node and/or other computer at time of selection. As a further example, encryption and/or authentication might, in various embodiments, be employed in communication between the user's node and/or other computer and the item.

As an additional example, functionality for selection via moving the node and/or other computer might, in various embodiments, be implemented such that the one or more movements acceptable as indicative of selection might not include movements thought (e.g., by a system administrator, user, and/or network provider) to be ones that the user might perform unintentionally.

As yet another example, functionality for allowing offering selection, perceived (e.g., by a system administrator, user, and/or network provider) to be more secure, might be employed in favor of functionality for allowing offering selection perceived to be less secure. For example, in various embodiments selection by way of the user juxtaposing her node and/or other computer with one or more items and/or in reading one or more memory elements (e.g., as discussed above) might be perceived to be more secure than various other ways of allowing for offering selection.

Hardware and Software

Various operations and/or the like described herein may, in various embodiments, be executed by and/or with the help of computers. Further, for example, devices and/or items described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, phone, communication device, node, and/or the like, a server, a network access point, a network multicast point, a network device, a set-top box, a personal video recorder (PVR), a game console, a portable game device, a portable audio device, a portable media device, a portable video device, a television, a digital camera, a digital camcorder, a Global Positioning System (GPS) receiver, a wireless personal sever, or the like, or any combination thereof, perhaps running an operating system such as OS X, Linux, Darwin, Windows CE, Windows XP, Windows Server 2003, Palm OS, Symbian OS, or the like, perhaps employing the Series 40 Platform, Series 60 Platform, Series 80 Platform, and/or Series 90 Platform, and perhaps having support for Java and/or .Net.

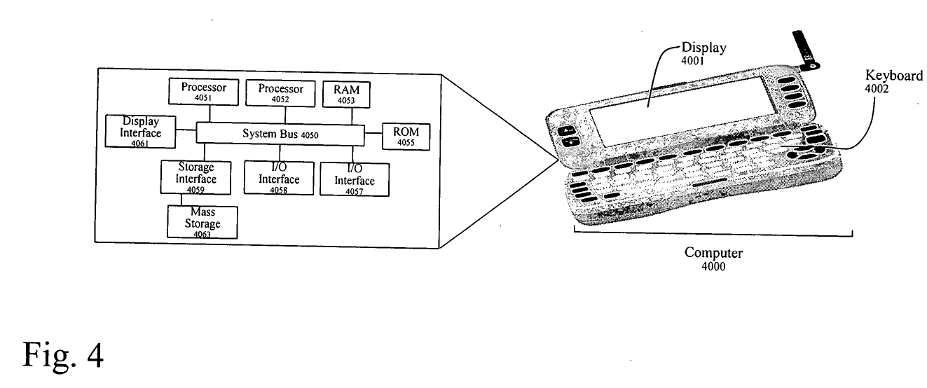

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Shown in FIG. 4 is an exemplary computer employable in various embodiments of the present invention. Exemplary computer 4000 includes system bus 4050 which operatively connects two processors 4051 and 4052, random access memory 4053, read-only memory 4055, input output (I/O) interfaces 4057 and 4058, storage interface 4059, and display interface 4061. Storage interface 4059 in turn connects to mass storage 4063. Each of I/O interfaces 4057 and 4058 may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee, Bluetooth, Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Global System for Mobile Communications (GSM), Code Division Multiple Access 2000 (CDMA2000), DVB-H (Digital Video Broadcasting: Handhelds), IrDA (Infrared Data Association), and/or other interface.

Mass storage 4063 may be a hard drive, optical drive, a memory chip, or the like. Processors 4051 and 4052 may each be a commonly known processor such as an IBM or Freescale PowerPC, an AMD Athlon, an AMD Opteron, an Intel ARM, an Intel XScale, a Transmeta Crusoe, a Transmeta Efficeon, an Intel Xenon, an Intel Itanium, an Intel Pentium, or an IBM, Toshiba, or Sony Cell processor. Computer 4000 as shown in this example also includes a touch screen 4001 and a keyboard 4002. In various embodiments, a mouse, keypad, and/or interface might alternately or additionally be employed. Computer 4000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, Python, and/or Comega according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve Simple Object Access Protocol (SOAP), Java Messaging Service (JMS), Remote Method Invocation (RMI), Remote Procedure Call (RPC), sockets, and/or pipes.

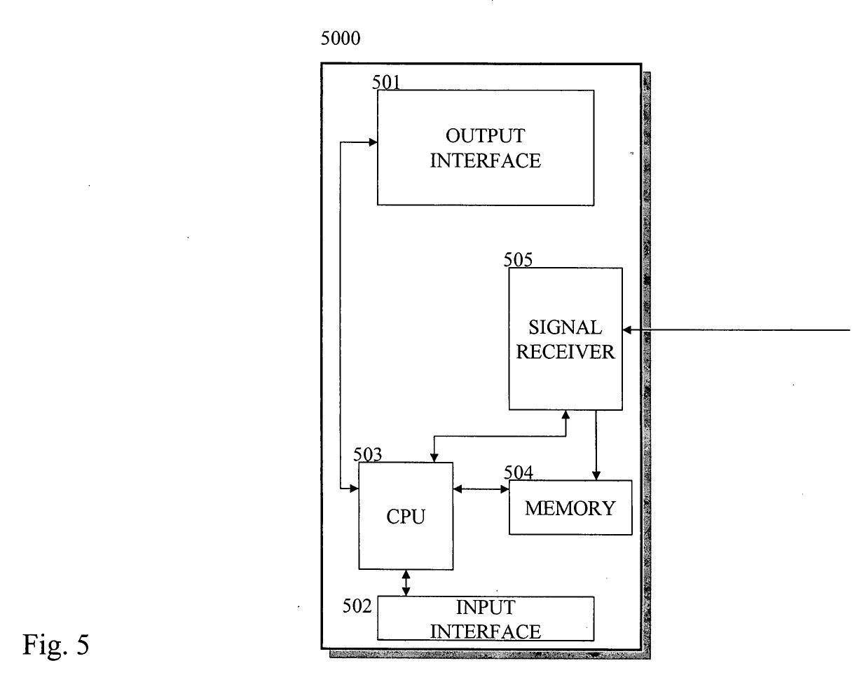

Shown in FIG. 5 is a block diagram of a terminal, an exemplary computer employable in various embodiments of the present invention. In the following, corresponding reference signs are applied to corresponding parts. Exemplary terminal 5000 of FIG. 5 comprises a processing unit CPU 503, a signal receiver 505, and a user interface (501, 502). Signal receiver 505 may, for example, be a single-carrier or multi-carrier receiver. Signal receiver 505 and the user interface (501, 502) are coupled with the processing unit CPU 503. One or more direct memory access (DMA) channels may exist between multi-carrier signal terminal part 505 and memory 504. The user interface (501, 502) comprises a display and a keyboard to enable a user to use the terminal 5000. In addition, the user interface (501, 502) comprises a microphone and a speaker for receiving and producing audio signals. The user interface (501, 502) may also comprise voice recognition (not shown).

The processing unit CPU 503 comprises a microprocessor (not shown), memory 504 and possibly software. The software can be stored in the memory 504. The microprocessor controls, on the basis of the software, the operation of the terminal 5000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 5, alternatively, middleware or software implementation can be applied. The terminal 5000 can, for instance, be a hand-held device which a user can comfortably carry. The terminal 5000 can, for example, be a cellular mobile phone which comprises the multi-carrier signal terminal part 505 for receiving multicast transmission streams. Therefore, the terminal 5000 may possibly interact with the service providers.

It is noted that various operations and/or the like described herein may, in various embodiments, be implemented in hardware (e.g., via one or more integrated circuits). For instance, in various embodiments various operations and/or the like described herein may be performed by specialized hardware, and/or otherwise not by one or more general purpose processors. One or more chips and/or chipsets might, in various embodiments, be employed. In various embodiments, one or more Application-Specific Integrated Circuits (ASICs) may be employed.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
receiving information from an item via a user juxtaposing a node with the item, wherein the information regards one or more offerings relating to the item;
presenting, to the user, a user interface regarding the offerings;
sensing spatial movements of the node caused by the user, wherein the movements are interpreted as instructions for controlling the user interface; and
displaying, via the user interface, navigation among the offerings.

2. The method of claim 1, wherein the juxtaposing involves the node touching the item.

3. The method of claim 1, wherein the juxtaposing involves the node reading a memory element.

4. The method of claim 1, wherein the juxtaposing is sensed.

5. The method of claim 1, further comprising receiving, from the user, indication of selection of one or more of the offerings.

6. The method of claim 5, wherein the user indicates selection by having a memory element read.

7. The method of claim 6, wherein the memory element is a radio frequency identification tag.

8. The method of claim 5, wherein the user indicates selection by juxtaposing the node with the item.

9. The method of claim 5, wherein the user indicates selection by spatially moving the node according to a predefined selection gesture.

10. The method of claim 1, further comprising performing one or more operations corresponding to one or more selected offerings.

11. The method of claim 1, further comprising accessing one or more services corresponding to selected offerings.

12. A method, comprising:
sensing being juxtaposed with a node; and
providing spatial movement interface provision information to the node,
wherein the node employs the information in providing an interface to a user at the node, wherein the user may, by spatially moving the node, navigate among one or more offerings indicated by the interface provided to the user.

13. The method of claim 12, wherein being touched by the node is sensed.

14. The method of claim 12, wherein being juxtaposed with the node involves the node performing a memory element reading operation.

15. The method of claim 12, wherein the node receives selection of one or more of the offerings, wherein the user indicates selection by spatially moving the node according to a predefined selection gesture.

16. The method of claim 12, wherein the node receives selection of one or more of the offerings, wherein the user indicates selection by juxtaposing the node with an item.

17. The method of claim 12, wherein the node receives selection of one or more of the offerings, wherein the user indicates selection by having a memory element read.

18. The method of claim 12, wherein the node performs one or more operations corresponding to one or more selected offerings.

19. The method of claim 12, further comprising providing, to the node, operation information corresponding to one or more of the offerings.

20. The method of claim 12, wherein the node accesses one or more services corresponding to selected offerings.

21. A system, comprising:
a memory having program code stored therein; and
a processor disposed in communication with the memory for carrying out instructions in accordance with the stored program code;
wherein the program code, when executed by the processor, causes the processor to perform:
receiving information from an item via a user juxtaposing a node with the item, wherein the information regards one or more offerings relating to the item;
presenting, to the user, a user interface regarding the offerings;
sensing spatial movements of the node caused by the user, wherein the movements are interpreted as instructions for controlling the user interface; and
displaying, via the user interface, navigation among the offerings.

22. The system of claim 21, wherein the juxtaposing involves the node touching the item.

23. The system of claim 21, wherein the juxtaposing involves the node reading a memory element.

24. The system of claim 21, wherein the juxtaposing is sensed.

25. The system of claim 21, wherein the processor further performs receiving, from the user, indication of selection of one or more of the offerings.

26. The system of claim 25, wherein the user indicates selection by having a memory element read.

27. The system of claim 26, wherein the memory element is a radio frequency identification tag.

28. The system of claim 25, wherein the user indicates selection by juxtaposing the node with the item.

29. The system of claim 25, wherein the user indicates selection by spatially moving the node according to a predefined selection gesture.

30. The system of claim 21, wherein the processor further performs one or more operations corresponding to one or more selected offerings.

31. The system of claim 21, wherein the processor further performs accessing one or more services corresponding to selected offerings.

32. A system, comprising:
a memory having program code stored therein; and
a processor disposed in communication with the memory for carrying out instructions in accordance with the stored program code;
wherein the program code, when executed by the processor, causes the processor to perform:
sensing being juxtaposed with a node; and
providing spatial movement interface provision information to the node,
wherein the node employs the information in providing an interface to a user at the node, wherein the user may, by spatially moving the node, navigate among one or more offerings indicated by the interface provided to the user.

33. The system of claim 32, wherein being touched by the node is sensed

34. The system of claim 32, wherein being juxtaposed with the node involves the node performing a memory element reading operation.

35. The system of claim 32, wherein the node receives selection of one or more of the offerings, wherein the user indicates selection by spatially moving the node according to a predefined selection gesture.

36. The system of claim 32, wherein the node receives selection of one or more of the offerings, wherein the user indicates selection by juxtaposing the node with an item.

37. The system of claim 32, wherein the node receives selection of one or more of the offerings, wherein the user indicates selection by having a memory element read.

38. The system of claim 32, wherein the node performs one or more operations corresponding to one or more selected offerings.

39. The system of claim 32, wherein the processor further performs providing, to the node, operation information corresponding to one or more of the offerings.

40. The system of claim 32, wherein the node accesses one or more services corresponding to selected offerings.

41. A node, comprising:
a memory having program code stored therein;
a processor disposed in communication with the memory for carrying out instructions in accordance with the stored program code; and
a network interface disposed in communication with the processor;
wherein the program code, when executed by the processor, causes the processor to perform:
receiving information from an item via a user juxtaposing the node with the item, wherein the information regards one or more offerings relating to the item;
presenting, to the user, a user interface regarding the offerings;
sensing spatial movements of the node caused by the user, wherein the movements are interpreted as instructions for controlling the user interface; and
displaying, via the user interface, navigation among the offerings.

42. An article of manufacture comprising a computer readable medium containing program code that when executed causes a node to perform:
receiving information from an item via a user juxtaposing the node with the item, wherein the information regards one or more offerings relating to the item;
presenting, to the user, a user interface regarding the offerings;
sensing spatial movements of the node caused by the user, wherein the movements are interpreted as instructions for controlling the user interface; and
displaying, via the user interface, navigation among the offerings.

43. An article of manufacture comprising a computer readable medium containing program code that when executed causes an item to perform:
sensing being juxtaposed with a node; and
providing spatial movement interface provision information to the node,
wherein the node employs the information in providing an interface to a user at the node, wherein the user may, by spatially moving the node, navigate among one or more offerings indicated by the interface provided to the user.
